(19) United States
(12) Patent Application Publication
(10) Pub. No.: US 2024/0420170 A1
(43) Pub. Date: Dec. 19, 2024

(54) METHOD AND DEVICE FOR PROVIDING GAME SERVICE

(71) Applicant: NEXON KOREA CORPORATION, Seongnam-si (KR)

(72) Inventors: Pil Ryoung LIM, Seongnam-si (KR); Hwi Jong KIM, Seongnam-si (KR); Chan Seop KIM, Seongnam-si (KR); Jeong Heon KIM, Seongnam-si (KR)

(21) Appl. No.: 18/744,350

(22) Filed: Jun. 14, 2024

(30) Foreign Application Priority Data
Jun. 16, 2023 (KR) 10-2023-0077455

(51) Int. Cl. G06Q 30/0201; A63F 13/69; A63F 13/792

(52) U.S. Cl. CPC G06Q 30/0206; A63F 13/69; A63F 13/792

(57) ABSTRACT

Provided is a method of providing a game service. The method may be performed by a game-providing device. The method includes obtaining enhancement information regarding enhancement conditions of a first item among items in a game. The method includes obtaining first user information indicating information about a user who uses the game at a first time point. The method includes determining a first enhancement price for enhancing the first item, based on the enhancement information and the first user information.

### CROSS-REFERENCE TO RELATED APPLICATION

This application is based on and claims priority under 35 U.S.C. § 119 to Korean Patent Application No. 10-2023-0077455, filed on Jun. 16, 2023, in the Korean Intellectual Property Office, the disclosure of which is incorporated by reference herein in its entirety.

### BACKGROUND

### Technical Field

The disclosure relates to a method and device for providing a game service. More specifically, the disclosure relates to a method and device for determining an enhancement price, based on enhancement information and user information.

### Description of the Related Art

Recently, the importance of dynamic pricing of adjusting the prices of products or services in real time to generate optimal profits or increase customer demands has emerged.

Likewise, in the gaming industry, a strategy of changing the price of an item by ascertaining and reflecting a user demand for the item is needed to prevent the value of the item from depreciating. In addition, there is a necessity for a system for enhancing items at reasonable prices by comprehensively considering all market conditions and allowing various items to be used in a game.

### BRIEF SUMMARY

One or more embodiments include a method and device for providing a game service, in which an enhancement price is determined by appropriately reflecting a demand for and a payment intention for enhancement of an item in a game.

Additional aspects will be set forth in part in the description which follows and, in part, will be apparent from the description, or may be learned by practice of the presented embodiments of the disclosure.

According to one or more embodiments, a method, performed by a game-providing device, of providing a game service includes obtaining enhancement information regarding enhancement conditions of a first item among items in a game, obtaining first user information indicating information about a user who uses the game at a first time point, and determining a first enhancement price for enhancing the first item, based on the enhancement information and the first user information.

According to one or more embodiments, a game-providing device includes a memory storing instructions, and at least one processor functionally connected to the memory and configured to execute the instructions. The at least one processor is configured to execute the instructions to obtain enhancement information regarding enhancement conditions of a first item among items in a game, obtain first user information indicating information about a user who uses the game at a first time point, and determine a first enhancement price for enhancing the first item, based on the enhancement information and the first user information.

According to one or more embodiments, a server includes a memory storing instructions, and at least one processor functionally connected to the memory and configured to execute the instructions. The at least one processor is configured to execute the instructions to obtain enhancement information regarding enhancement conditions of a first item among items in a game, obtain first user information indicating information about a user who uses the game at a first time point, and determine a first enhancement price for enhancing the first item, based on the enhancement information and the first user information.

According to one or more embodiments, a user terminal includes a user interface configured to receive a user input, a memory storing instructions, and at least one processor functionally connected to the user interface and the memory and configured to execute the instructions. The at least one processor is configured to execute the instructions to obtain enhancement information regarding enhancement conditions of a first item among items in a game, obtain first user information indicating information about a user who uses the game at a first time point, and determine a first enhancement price for enhancing the first item, based on the enhancement information and the first user information.

According to one or more embodiments, a computer-readable recording medium has recorded thereon a program, which, when executed by a computer, performs a method of providing a game service, the method including obtaining enhancement information regarding enhancement conditions of a first item among items in a game, obtaining first user information indicating information about a user who uses the game at a first time point, and determining a first enhancement price for enhancing the first item, based on the enhancement information and the first user information.

### BRIEF DESCRIPTION OF THE SEVERAL VIEWS OF THE DRAWINGS

The above and other aspects, features, and advantages of certain embodiments of the inventive concept will be more apparent from the following description taken in conjunction with the accompanying drawings, in which:

FIG. 1 illustrates a game providing system including a server and a user terminal, according to various embodiments;

FIG. 2 is a conceptual diagram for explaining a method of determining an enhancement price, according to an embodiment;

FIG. 3 is a conceptual diagram for explaining a method of adjusting and determining an enhancement price, according to an embodiment;

FIG. 4 is a flowchart of a method of providing a game service, according to an embodiment;

FIG. 5 is a flowchart of a method of adjusting an enhancement price, according to an embodiment;

FIG. 6 is a flowchart of a detailed method of adjusting an enhancement price, according to an embodiment;

FIG. 7 is a flowchart of an operation of determining an enhancement price, based on an enhancement demand, according to an embodiment;

FIG. 8 is a flowchart of an operation of determining an enhancement price by using an intermediate price, according to an embodiment;

FIG. 9 is a block diagram of a specific configuration of a game-providing device according to various embodiments;

FIG. 10 is a block diagram of a specific configuration of a server according to various embodiments; and

FIG. 11 is a block diagram of a specific configuration of a user terminal according to various embodiments.

### DETAILED DESCRIPTION

Throughout the disclosure, the expression “at least one of a, b or c” indicates only a, only b, only c, both a and b, both a and c, both b and c, all of a, b, and c, or variations thereof.

Reference will now be made in detail to embodiments, examples of which are illustrated in the accompanying drawings. A method of constructing and using an electronic device, according to an embodiment, will now also be described with reference to the accompanying drawings. Like reference numerals or characters in the drawings denote like parts or components.

While such terms including ordinal numbers such as “first,” “second,” etc., may be used to describe various components, such components should not be limited to the above terms. The above terms are used only to distinguish one component from another. For example, a first component discussed below could be termed a second component, and similarly, a second component may be termed a first component, without departing from the teachings of this disclosure. The term “and/or” includes any and all combinations of one or more of the associated listed items.

The terms used in the present specification are merely used to describe particular embodiments, and are not intended to limit the disclosure. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Throughout the specification, when an element is referred to as being “connected” or “coupled” to another element, it can be directly connected or coupled to the other element, or can be electrically connected or coupled to the other element with intervening elements interposed therebetween. The terms “comprises” and/or “comprising” or “includes” and/or “including” when used in this specification, specify the presence of stated elements, but do not preclude the presence or addition of one or more other elements.

The terms “unit,” “-er (-or),” and “module” when used in this specification refers to a unit in which at least one function or operation is performed, and may be implemented as hardware, software, or a combination of hardware and software. More specifically, the term “unit” may include any electrical circuitry, features, components, an assembly of electronic components or the like. That is, “unit” may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit.”

In the disclosure below, a game-providing device may be a game server, a user terminal, a game system including a game server and a user terminal, or an independent device (e.g., video game console, or the like).

In the disclosure below, a server controlling a user terminal may refer to the server providing data used by outputs of a user terminal (all output devices of the user terminal, such as a screen display, a sound output, a vibration output, and lamp emission) and the user terminal to perform a certain operation through communication with the user terminal. Of course, the user terminal may control an output of the user terminal by using pre-stored data. Embodiments are not limited to the above example.

In the disclosure below, transmitting and receiving information or data to and from a user (or a user account) may include the meaning of transmitting and receiving information or data to and from a device (or a user terminal) corresponding to or linked to the user (or the user account).

In the disclosure below, a user, a player, a user, a user account, and a gamer may be understood as having the same meaning as each other. In the disclosure, it should be understood that the user terminal may indicate a user, a player, a user account, or a gamer, or may indicate a device used by them, depending on the context. In the disclosure, it should be understood that a user, a player, a user account, or a gamer may indicate, an avatar or character manipulated by them or may indicate a device used by them, depending on the context.

In the disclosure below, an ‘item’ may include all objects, goods, content, etc., and may refer to, but is not limited to, equipment worn by in-game characters (such as, weapons, armor, clothes, and crystals), vehicles ridden by in-game characters, consumables (such as, food and potions), all digital content obtainable by a user within the game (such as, experience points and buffs), and cyber objects.

In the disclosure below, ‘enhancement’ may refer to an action to improve the performance or abilities of an item, and may include an attempt to improve the performance or abilities of the item. The term ‘enhancement’ may be a concept including obtaining a penalty for an item through an attempt to improve the item's performance, and may include any action to change the item's abilities. The enhancement may include direct or indirect means for the item that is to be enhanced.

In the disclosure below, an ‘enhancement price’ refers to the amount of goods needed to enhance an item, and may mean money, goods, or other services needed to enhance the item in a game.

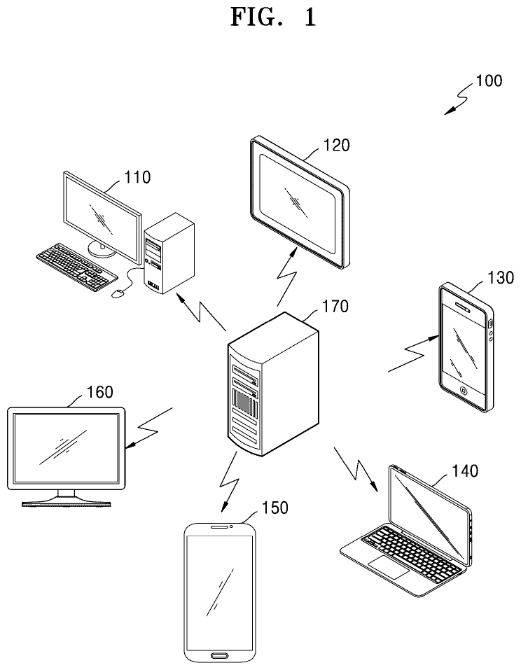

FIG. 1 illustrates a game providing system including a server and a user terminal, according to various embodiments.

A game providing system 100 according to the disclosure may include a server 170 and one or more user terminals 110 through 160. The server 170 may provide various online activities to the one or more user terminals 110 through 160 through a network. The server 170 may simultaneously provide an online activity to the one or more user terminals 110 through 160.

In an embodiment, the server 170 may include, but is not limited to, a single server, a collection of servers, a cloud server, etc. The server 170 may provide various online activities to the one or more user terminals 110 through 160, and may include a database that stores data for an online activity of the one or more user terminals 110 through 160. The server 170 may also include a payment server that generates and processes payment events. As described above, the server 170 may be a game-providing device.

In an embodiment, a network refers to a connection established (or formed) using all communication methods, and may refer to a communication network connected through all communication methods of transmitting and receiving data between terminals and between a terminal and a server.

The all communication methods may include communication via a selected communication standard, a selected frequency band, a selected protocol, or a selected channel. For example, the all communication methods may include communication methods via Bluetooth, BLE, Wi-Fi, Zigbee, 3G, LTE, and ultrasound waves, and may include all of short-range communication, long-range communication, wireless communication, and wired communication. Embodiments are not limited thereto.

In an embodiment, the short-range communication method may refer to a communication method that allows communication only when a device (terminal or server) performing communication is within a selected range, and, for example, may include Bluetooth, NFC, etc. The long-range communication method may refer to a communication method in which a device performing communication is able to communicate regardless of a distance. For example, the long-range communication method may refer to a method enabling communication even when two devices that perform communication through a repeater such as an AP is equal to or greater than a selected distance, and may include a communication method using a cellular network (3G, LTE, etc.) such as a short message service (SMS) or a telephone. Embodiments are not limited thereto. Receiving online activities by using a network may include a meaning that communication between a server and a terminal can be performed through any communication method.

Throughout the specification, the one or more user terminals 110 through 160 may include, but are not limited to, various electronic devices, such as not only a personal computer 110, a tablet 120, a cellular phone 130, a laptop 140, a smartphone 150, and a TV 160, but also personal digital assistants (PDAs), a portable multimedia player (PMP), a navigation device, an MP3 player, a digital camera, a refrigerator, a washing machine, and a vacuum cleaner. As described above, the one or more user terminals 110 through 160 may be game-providing devices.

In an embodiment, online activities may include, but are not limited to, an online game, a portal service, and a social network service (SNS). Examples of the online game may include a variety of genres, including sports, MMORPG, AOS, FPS, TCG, and CCG. The online game may be a game that pit users against each other, or between a user and a computer (for example, artificial intelligence). Of course, the online game is not limited to the above examples, and there are no restrictions on the form of online games.

A game-providing device according to an embodiment may obtain enhancement information regarding enhancement conditions for enhancing a selected item. The game-providing device according to an embodiment may also obtain user information related to a user corresponding to each of a plurality of viewpoints. The game-providing device may provide a game service that determines the price of means for enhancing an item, by comprehensively considering the enhancement information and the user information.

In an embodiment, the game providing system 100 may obtain enhancement information regarding enhancement conditions for at least one item among items in a game. The game providing system 100 may obtain user information indicating information about a user who uses the game at at least one time point. The game providing system 100 may determine an enhancement price, based on the enhancement information and the user information.

In an embodiment, the server 170 may obtain the enhancement information regarding enhancement conditions for at least one item among items in a game. The server 170 may obtain the user information indicating information about a user who uses the game at at least one time point. The server 170 may determine the enhancement price, based on the enhancement information and the user information.

In an embodiment, one of the one or more user terminals 110 through 160 may obtain the enhancement information regarding enhancement conditions for at least one item among items in a game. The one of the one or more user terminals 110 through 160 may obtain the user information indicating information about a user who uses the game at at least one time point. The one of the one or more user terminals 110 through 160 may determine an enhancement price, based on the enhancement information and the user information.

In an embodiment, some or all of the operations of the server 170 may be performed in the user terminals 110 through 160. For example, a method of providing a game service, according to various embodiments, may be performed by the user terminals 110 through 160 without communication with the server 170.

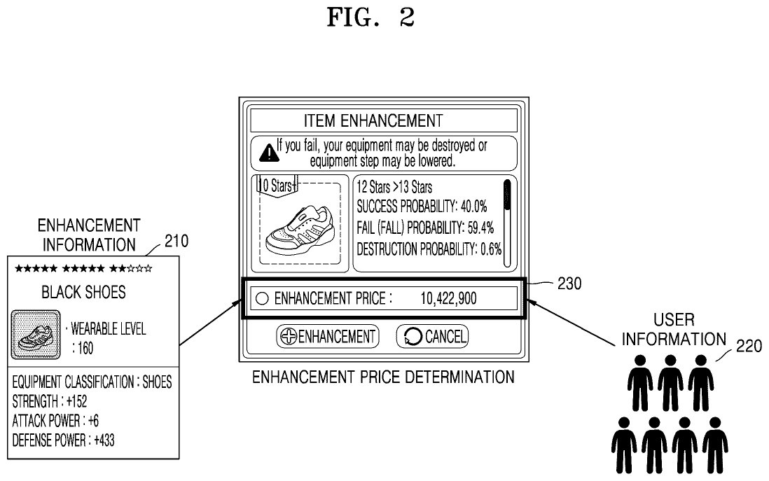

FIG. 2 is a conceptual diagram for explaining a method of determining an enhancement price, according to an embodiment.

In an embodiment, a game-providing device may obtain enhancement information 210 regarding enhancement conditions for at least one item among items in a game. For example, the game-providing device may obtain enhancement information regarding enhancement conditions of ‘black shoes’ among the items in a game.

In an embodiment, the enhancement information may represent pieces of information about conditions associated with enhancement for an item that is to be enhanced. For example, the enhancement information 210 may include, but is not limited to, the type of enhancement, an enhancement section, the number of consecutive enhancements, a wearable level, and the ability value of the item that is to be enhanced.

In an embodiment, enhancement information 210 associated with enhancement conditions for black shoes may include information indicating that step-by-step enhancement is possible for black shoes and additional capability resetting for black shoes is possible. When step-by-step enhancement is possible for black shoes, the enhancement information 210 may include information about the enhancement section indicating an enhancement step for the black shoes, which are the item that is to be enhanced. The enhancement information 210 may include information that the wearable level of the black shoes is level 160. The enhancement information 210 about the black shoes may include information about the abilities of the black shoes which indicates that, when the black shoes are worn, a strength increases by 152, attack power increases by 6, and defense power increases by 433.

In an embodiment, the game-providing device may obtain user information 220 indicating information about a user who uses the game. The user information 220 may be information obtained from multiple users who use the game.

In an embodiment, the user information 220 may include, but is not limited to, the amount of goods distributed to the users of the game service, the number of users, an average profit of users in the game, an enhancement demand for a certain item, the number of users for each level section, an average profit of the users for each level section, an enhancement demand of the users for each level section for a certain item, and an increase/decrease rate of enhancement demand according to a point in time. The user information 220 may vary depending on a point in time at which information is obtained. For example, first user information corresponding to a first time point and second user information corresponding to a second time point may be different from each other.

In an embodiment, the user information 220 may include values for users for each level section. For example, the number of users in each level section or the average profit of users in each level section may be a value for considering the actual demanders of the item to be enhanced or respective economic situation of the actual demanders of the item to be enhanced. The users for each level section may represent users in the level section within a selected range from the wearable level of the item to be enhanced. The game-providing device may obtain the user information 220, based on the previously-obtained enhancement information 210, or may obtain the user information 220 regardless of the previously-obtained enhancement information 210.

The user information 220, which represents information about users who use the game, is not limited thereto, and may include all information about users that are available as a factor for determining an enhancement price 230.

In an embodiment, the game-providing device may determine the enhancement price 230 for enhancing the item to be enhanced, based on the obtained enhancement information 210 and the obtained user information 220. For example, when the item to be enhanced is black shoes, the game-providing device may determine the enhancement price 230 indicating the amount of goods needed to enhance the black shoes, based on the enhancement information 210 about the enhancement conditions of the black shoes and the user information 220 about the users who use the game at a certain point in time.

In an embodiment, the game-providing device may determine the enhancement price 230 to be 10,422,900, by comprehensively considering enhancement information 210 regarding enhancement conditions of the black shoes indicating that the type of enhancement of the black shoes is step-by-step enhancement, the enhancement section is a 13^{th} level, and the wearable level of the black shoes is level 160, and user information 220 including, for example, the average profit of users at levels 150 through 170 and the enhancement demands of the users at levels 150 through 170. This is only one example, and the method of determining the enhancement price 230 is not limited to the disclosed example.

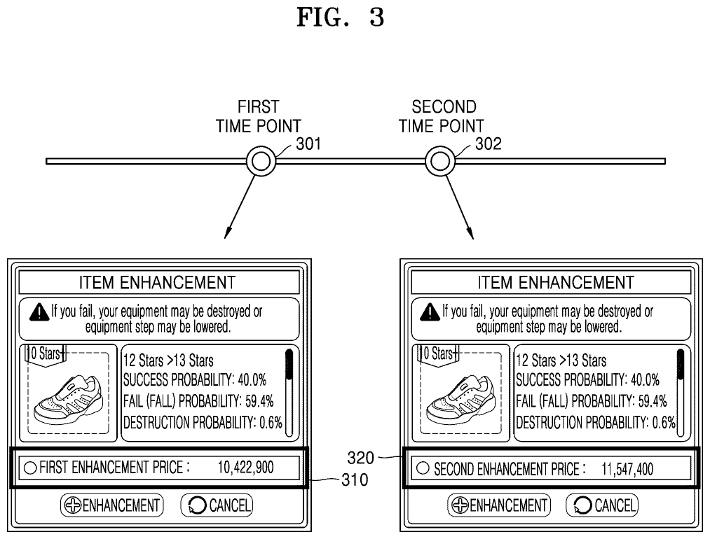

FIG. 3 is a conceptual diagram for explaining a method of adjusting and determining an enhancement price, according to an embodiment.

In an embodiment, the game-providing device may obtain user information regarding a user who uses a game at at least one time point. For example, the game-providing device may obtain first user information indicating information about a user who uses the game at a first time point 301. The game-providing device may obtain second user information indicating information about a user who uses the game at a second time point 302. Hereinafter, the user information may be information including the first user information and the second user information.

In an embodiment, the user information may be calculated using data at one point in time or within a selected period of time from the one point in time, or may be a value calculated using all data before the one point in time. For example, the number of users included in the second user information may refer to values based on the second time point 302. The value based on the second time point 302 may represent information calculated based on data up to the second time point 302, or may represent information calculated based on the data up to the first time point 301, which is a selected time before the second time point 302.

In an embodiment, the number of users included in the second user information may be a value indicating the number of users who have played the game within the last 7 days based on the second time point 302. The number of users for each level section included in the second user information may be a value indicating the number of users for each level section, based on the second time point 302. An enhancement demand of users for each level section for a selected item included in the second user information may be a value calculated by considering the number of enhancements performed during a period from the first time point 301 to the second time point 302. An enhancement demand increase/decrease rate included in the second user information may be a value corresponding to a comparison between an enhancement demand calculated at the first time point 301 and an enhancement demand calculated at the second time point 302. A method of obtaining the user information is not limited thereto.

In an embodiment, the game-providing device may obtain enhancement information regarding enhancement conditions of a first item among the items in a game. For example, the game-providing device may obtain enhancement information about ‘black shoes.’

In an embodiment, the game-providing device may determine a first enhancement price 310 for enhancing the first item, based on the enhancement information and the first user information. For example, the game-providing device may determine the first enhancement price 310 needed to enhance a black shoes item, by comprehensively considering the enhancement information of the black shoes and the first user information.

In an embodiment, the game-providing device may determine a second enhancement price 320 for enhancing the first item, based on the enhancement information and the second user information. For example, the game-providing device may determine the second enhancement price 320 needed to enhance the black shoes item, by comprehensively considering the enhancement information of the black shoes and the second user information.

In an embodiment, the enhancement information about the black shoes used to calculate the first enhancement price 310 and the second enhancement price 320 may include information that step-by-step enhancement may be performed with respect to the black shoes, and the enhancement section may be the 13th.

In an embodiment, the game-providing device may compare the enhancement demand calculated based on the first time point 301 and the enhancement demand calculated based on the second time point 302 in order to determine the second enhancement price 320. When the enhancement demand calculated based on the second time point 302 is higher than the enhancement demand calculated based on the first time point 301, the game-providing device may determine the second enhancement price 320 to be a value higher than the first enhancement price 310. For example, when the first enhancement price 310 is 10,422,900 and the enhancement demand calculated based on the second time point 302 is higher than the enhancement demand calculated based on the first time point 301, the second enhancement price 320 may be determined as 11,547,400 that is higher than the first enhancement price 310. The first enhancement price 310 and the second enhancement price 320 may be collectively referred to as an enhancement price, and the method of determining the enhancement price is not limited thereto.

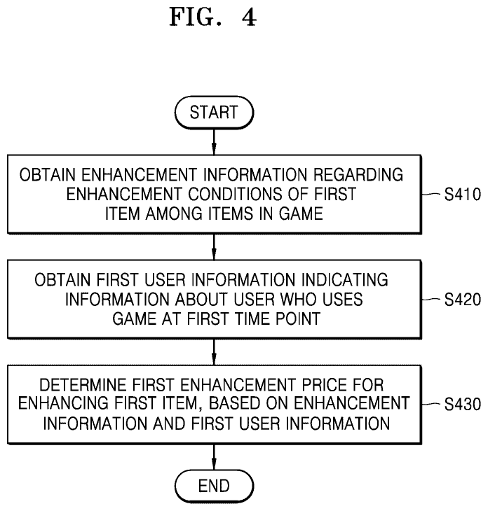

FIG. 4 is a flowchart of a method of providing a game service, according to an embodiment.

In operation S410, the game-providing device may obtain enhancement information regarding enhancement conditions of a first item among the items in a game.

In an embodiment, the enhancement information may represent pieces of information about conditions associated with enhancement for the first item. For example, the enhancement information may include, but is not limited to, at least one of the enhancement type of the first item, an enhancement section of the first item, the number of consecutive enhancements of the first item, a wearable level of the first item, and the ability value of the first item.

In an embodiment, the enhancement type represents the types of various pieces of content that exist within a game service for enhancing a game item. Examples of the enhancement type include, but are not limited to, conditional enhancement in which an item is enhanced when a selected condition is satisfied, probability-type enhancement in which an item is enhanced according to probability, and step-by-step enhancement in which an item is enhanced in stages. Multiple enhancement types may be combined and represent one enhancement type. For example, step-by-step enhancement may be performed on a selected item, and an enhancement success probability may be different for each enhancement section.

In an embodiment, the enhancement section may indicate an enhancement step when an item may be enhanced step by step. For example, when enhancement has already been performed 12 times on the first item, the enhancement section may be a 13^{th} step. To prevent devaluation of a high-value item, the higher the enhancement section is, the higher the enhancement price may be set.

In an embodiment, the number of consecutive enhancements may indicate the number of times an enhancement is consecutively conducted. For example, when enhancement is performed within a selected time period from a time point when the last enhancement has been performed on the first item, this may be considered consecutive enhancements, and the number of times consecutive enhancements have been performed may be considered the number of consecutive enhancements.

In an embodiment, the wearable level may indicate the level of a user who is able to wear the item that is to be enhanced. For example, when a minimum level of the user required to wear the first item is 160, the wearable level of the first item may be 160.

In an embodiment, the ability value of the item to be enhanced may be a numerical value representing the performance of the item to be enhanced. For example, if a strength increases by 152 when the first item is worn, the ability value of the first item may be an increase in strength by 152.

There may be a first item and a second item that may be used in the same level section. When the ability of the first item is relatively better than the ability of the second item and respective enhancement prices of the two first and second items are the same, users may attempt to enhance only the first item. However, when the enhancement price of the first item is lower than that of the second item, users may attempt to enhance even the second item. When the enhancement price is determined considering the user's demand based on the item's ability, a consumer may proceed with enhancement at a reasonable price, and, because various items may be used in the game, the ability of the item to be enhanced may be considered as enhancement information.

The enhancement information regarding the enhancement conditions for the item to be enhanced is not limited to the disclosed example, and may represent all pieces of information associated with the enhancement conditions.

In operation S420, the game-providing device may obtain first user information indicating information about a user who uses the game at a first time point.

In an embodiment, the game-providing device may obtain first user information indicating information about a user who uses the game based on the first time point. The game-providing device may obtain first user information including at least one of the amount of goods distributed to the users of the game service, the number of users, an average profit of users, an enhancement demand for the first item, the number of users for each level section, an average profit of the users for each level section, an enhancement demand of the users for each level section for the first item, and an increase/decrease rate of enhancement demand, based on the first time point.

In an embodiment, the user who uses the game may include a user having a level within a selected range from the wearable level of the first item. For example, when the wearable level of the first item is 160, the user who uses the game may be a user of level 150 to 170, or may be a user of level 160 to 180.

Even when users are willing to pay an enhancement price, when goods are not enough, it may not be possible to pay the enhancement price, so the enhancement price may be determined by considering the user's average profit, etc.

It is difficult for users with low levels or little capital to perform enhancement due to enhancement attempts by users with high levels or a lot of capital, so, in order to prevent an increase in the barrier to the inflow of new users, user information including, for example, information associated with users for each level section may be comprehensively considered.

The first user information is not limited to the disclosed example, and may include information about all users that are available as a factor for determining an enhancement price based on the first time point.

In operation S430, the game-providing device may determine a first enhancement price for enhancing the first item, based on the enhancement information and the first user information.

In an embodiment, the game-providing device may determine the first enhancement price for the first item at the first time point, by comprehensively considering the enhancement information of the first item and the first user information of the first time point. For example, when stochastic enhancement is desired to be performed on the first item at the first time point, the game-providing device may determine the first enhancement price necessary for performing stochastic enhancement of the first item by considering the average profit of users within a selected range from the wearable level of the first item.

$$Price = 0.9 * BasePrice + 0.1 ⋆ BasePrice ⋆ Multiplier$$

In an embodiment, the game-providing device may determine the enhancement price by using the above equation. Price may represent the first enhancement price, and Multiplier is a variable determined based on the enhancement information and the first user information and may represent a value of 1 or more. BasePrice represents a preset basic price for the first item, and may be a value representing a minimum enhancement price.

In the above equation, a unit of change in the enhancement price is set to be 10% of the minimum enhancement price, but the unit of change in the enhancement price is not limited thereto.

The minimum enhancement price may vary depending on enhancement information regarding each item and the enhancement conditions of each item.

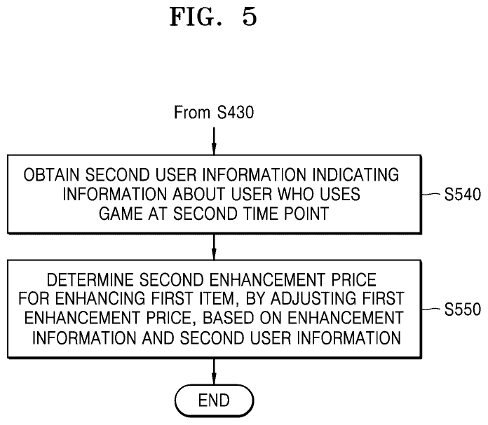

FIG. 5 is a flowchart of a method of adjusting an enhancement price, according to an embodiment.

In operation S540, the game-providing device may obtain second user information indicating information about a user who uses the game at a second time point.

In an embodiment, operation S540 may be an operation that is performed after operation S430.

In an embodiment, the game-providing device may obtain second user information indicating information associated with a user of a game service, based on the second time point. The game-providing device may obtain second user information including at least one of the amount of goods distributed to the users of the game service, the number of users, an average profit of users, an enhancement demand for the first item, the number of users for each level section, an average profit of the users for each level section, an enhancement demand of the users for each level section for the first item, and an increase/decrease rate of enhancement demand, based on the second time point.

The second user information corresponds to the first user information, and a redundant description thereof will be omitted.

In an embodiment, the game-providing device may use, as the second time point, a time point at which a preset time period has elapsed from the first time point, and the game-providing device may obtain the second user information, based on the second time point. The game-providing device may obtain or update user information at preset time intervals. The game-providing device may obtain and store the first user information and the second user information, and may analyze them. The first user information and the second user information may be the same as each other or different from each other.

A time period between the first time point and the second time point may be a fixed value or may be a changing value. The time period between the first time point and the second time point may be N times an adjustment period for the enhancement price.

In operation S550, the game-providing device may determine a second enhancement price for enhancing the first item, by adjusting the first enhancement price, based on the enhancement information and the second user information.

In an embodiment, the game-providing device may determine the second enhancement price for enhancement of the first item by comprehensively considering the enhancement information of the first item and the second user information of the first time point. The second enhancement price may be a value based on the first enhancement price, or may be a value based on a preset basic price in correspondence with the first item. The game-providing device may determine the first enhancement price for the first item and may present the first enhancement price through a user interface, and, after a selected time period, may determine the second enhancement price for the first item and present the second enhancement price through a user interface. The second enhancement price may be determined in the same way as the way of determining the first enhancement price, and a redundant description thereof is omitted.

In an embodiment, the game-providing device may determine the second enhancement price by adjusting the first enhancement price, based on the enhancement information and the second user information. For example, when an enhancement demand for the first item included in the second user information is 150% of an enhancement demand for the first item included in the first user information, the game-providing device may determine the second enhancement price to be 1.5 times the first enhancement price. Alternatively, when an average profit of users for each level section included in the second user information is 120% of an average profit of users for each level section included in the first user information, the game-providing device may determine the second enhancement price to be 1.2 times the first enhancement price.

In an embodiment, when an enhancement demand of a user for each level section included in the second user information is 90% of an enhancement demand of a user for each level section included in the first user information, the game-providing device may determine the second enhancement price to be 0.9 times the first enhancement price. Alternatively, when there is no enhancement demand for the first item based on the second user information, the game-providing device may determine the second enhancement price through a reverse auction for a preset minimum enhancement price.

The method of determining the second enhancement price by adjusting the first enhancement price is not limited to the disclosed example.

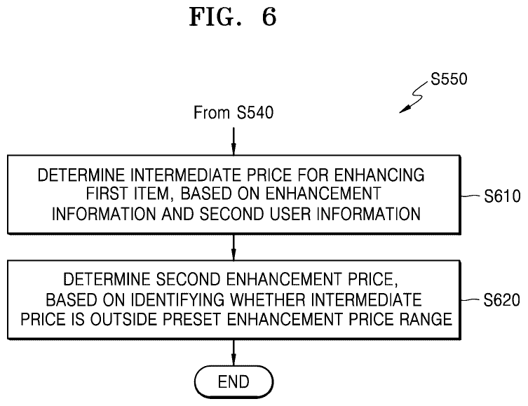

In an embodiment, the game-providing device may limit an enhancement price range in order to gradually change the second enhancement price. This will be described in greater detail later with reference to FIGS. 6 through 8.

FIG. 6 is a flowchart of a detailed method of adjusting an enhancement price, according to an embodiment.

In operation S610, the game-providing device may determine an intermediate price for enhancing the first item, based on the enhancement information and the second user information.

In an embodiment, operation S610 may be an operation that is performed after operation S540.

In an embodiment, the game-providing device may calculate the intermediate price for enhancing the first item, by comprehensively considering the enhancement information and the second user information. The intermediate price is a price calculated in a process of determining the second enhancement price, and may be the same as or different from the second enhancement price. For example, when the enhancement demand obtained based on the second user information for the first item is three times the enhancement demand obtained based on the first user information for the first item, the game-providing device may determine 3 times the first enhancement price as the intermediate price. In detail, when the first enhancement price is 10,000, the game-providing device may obtain an intermediate price of 30,000.

In operation S620, the game-providing device may determine the second enhancement price, based on identifying whether the intermediate price is outside a preset enhancement price range.

In an embodiment, the game-providing device may set an enhancement price range to be a value based on the first enhancement price, or may set the enhancement price range to be a fixed value regardless of the first enhancement price. For example, the game-providing device may set the enhancement price range to be 50% to 150% of the first enhancement price. When the first enhancement price is 10,000, the enhancement price range may be 5,000 to 15,000.

In an embodiment, the game-providing device may identify whether the intermediate price is outside the preset enhancement price range, and may determine the second enhancement price, based on a result of the identification.

In an embodiment, when the intermediate price is outside the preset enhancement price range, the game-providing device may determine one value within the preset enhancement price range as the second enhancement price. For example, when the intermediate price is 30,000 and the preset enhancement price range is 5,000 to 15,000, the game-providing device may identify that the intermediate price is not within the preset enhancement price range. After it is identified that the intermediate price is not a value within the preset enhancement price range, the game-providing device may determine one value between 5,000 and 15,000 as the second enhancement price.

In an embodiment, when the intermediate price is not outside the preset enhancement price range, the game-providing device may determine a value equal to the intermediate price as the second enhancement price. For example, when the intermediate price is 30,000 and the preset enhancement price range is 20,000 to 40,000, the game-providing device may identify that the intermediate price is a value within the preset enhancement price range. Because it is identified that the intermediate price is within the preset enhancement price range, the game-providing device may determine the second enhancement price to be 30,000 equal to the intermediate price.

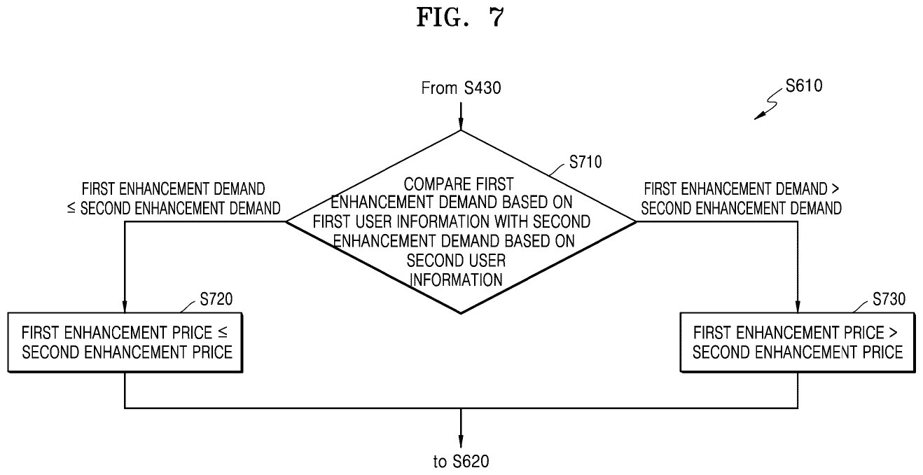

FIG. 7 is a flowchart of an operation of determining an enhancement price, based on an enhancement demand, according to an embodiment.

In operation S710, the game-providing device may compare a first enhancement demand based on the first user information with a second enhancement demand based on the second user information.

In an embodiment, operation S710 may be an operation that is performed after operation S430.

In an embodiment, the game-providing device may obtain the first enhancement demand for the first item, based on the first user information at the first time point, and may obtain the second enhancement demand for the first item, based on the second user information at the second time point. The game-providing device may compare the first enhancement demand based on the first user information with the second enhancement demand based on the second user information. The game-providing device may determine the intermediate price by adjusting the first enhancement price, based on a result of the comparison between the first enhancement demand and the second enhancement demand. The game-providing device may determine the second enhancement price, based on the intermediate price.

In an embodiment, the game-providing device may perform operation S720 when the second enhancement demand is greater than or equal to the first enhancement demand. The game-providing device may perform operation S730 when the second enhancement demand is less than the first enhancement demand.

In operation S720, the game-providing device may obtain an intermediate price that is higher than or equal to the first enhancement price, based on the second enhancement demand being higher than or equal to the first enhancement demand. The game-providing device may determine the second enhancement price, based on the intermediate price that is higher than or equal to the first enhancement price.

In operation S730, the game-providing device may obtain an intermediate price that is lower than the first enhancement price, based on the second enhancement demand being lower than the first enhancement demand. The game-providing device may determine the second enhancement price, based on the intermediate price that is less than the first enhancement price.

For convenience of explanation, a case where the second enhancement price is determined considering the enhancement demand among the user information has been illustrated and described. However, the game-providing device may determine the intermediate price and the second enhancement price, based on at least one of the amount of goods distributed to users, the number of users, an average profit of users, an enhancement demand for the first item, the number of users for each level section, an average profit of the users for each level section, an enhancement demand of the users for each level section for the first item, and an increase/decrease rate of the enhancement demand.

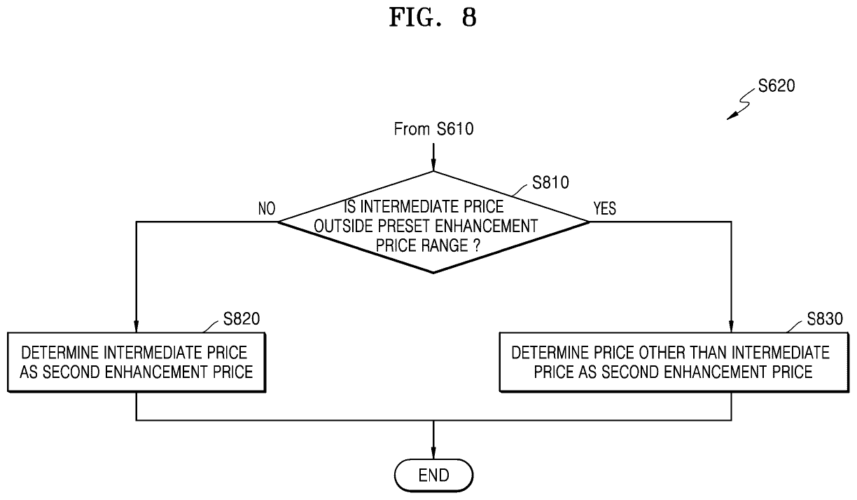

FIG. 8 is a flowchart of an operation of determining an enhancement price by using an intermediate price, according to an embodiment.

In operation S810, the game-providing device may identify whether the intermediate price is outside a preset enhancement price range.

In an embodiment, operation S810 may be an operation that is performed after operation S610.

In an embodiment, the game-providing device may identify whether the intermediate price is outside the preset enhancement price range, by comparing the intermediate price with the preset enhancement price range.

In an embodiment, when the intermediate price is not outside the preset enhancement price range, the game-providing device may perform operation S820. When the intermediate price is outside the preset enhancement price range, the game-providing device may perform operation S830.

In operation S820, the game-providing device may determine the intermediate price as the second enhancement price.

In an embodiment, when the intermediate price is 12,000 and the preset enhancement price range is 5,000 to 15,000, the game-providing device may determine the second enhancement price to be 12,000.

In operation S830, the game-providing device may determine a price other than the intermediate price as the second enhancement price.

In an embodiment, when the intermediate price is outside the preset enhancement price range, the game-providing device may determine, as the second enhancement price, a value indicating an upper limit or lower limit of the preset enhancement price range. For example, when the intermediate price is 30,000 and the preset enhancement price range is 5,000 to 15,000, the game-providing device may determine the second enhancement price to be a value different from the intermediate price. For example, because the intermediate price is higher than the upper limit of the preset enhancement price range, the game-providing device may determine the second enhancement price to be 15,000, which is the upper limit of the preset enhancement price range. For example, when the intermediate price is 3,000 and the preset enhancement price range is 5,000 to 15,000, the game-providing device may determine the second enhancement price to be a value different from the intermediate price. For example, because the intermediate price is higher than the lower limit of the preset enhancement price range, the game-providing device may determine the second enhancement price to be 5,000, which is the lower limit of the preset enhancement price range.

In an embodiment, when the intermediate price is outside the preset enhancement price range, the game-providing device may determine an enhancement price determined at one previous time point as the second enhancement price. For example, when the intermediate price is outside the preset enhancement price range, the game-providing device may determine a value equal to the first enhancement price as the second enhancement price. For example, when the intermediate price is 30,000 and the preset enhancement price range is 5,000 to 15,000, the game-providing device may determine, as the second enhancement price, a value of 10,000 equal to the first enhancement price.

The enhancement price determined at one previous time point is not limited to the first enhancement price based on the first user information at the first time point.

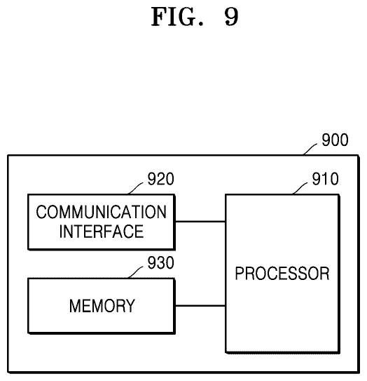

FIG. 9 is a block diagram of a specific configuration of a game-providing device according to various embodiments.

Referring to FIG. 9, a game-providing device 900 according to some embodiments may include at least one processor 910, a communication interface 920, and a memory 930. Not all of the components illustrated in FIG. 9 are essential components of the game-providing device 900. More or less components than those illustrated in FIG. 9 may constitute the game-providing device 900. The game-providing device 900 may be a user terminal, a server, a game network system, or a separate device.

In an embodiment, the processor 910 typically controls an overall operation of the game-providing device 900. For example, the processor 910 may control the communication interface 920, the memory 930, etc., in general by executing a program stored in the memory 930. The processor 910 may control an operation of the game-providing device 900 in this specification by controlling the communication interface 920, the memory 930, etc.

In an embodiment, the processor 910 may obtain enhancement information regarding the enhancement conditions of the first item among the items in a game, obtain the first user information indicating information about a user who uses the game at the first time point, and determine the first enhancement price for enhancing the first item, based on the enhancement information and the first user information.

In an embodiment, the processor 910 may obtain the second user information indicating information about a user who uses the game at the second time point, and may determine the second enhancement price for enhancing the first item, by adjusting the first enhancement price, based on the enhancement information and the second user information.

In an embodiment, the processor 910 may determine the intermediate price for enhancing the first item, based on the enhancement information and the second user information, and may determine the second enhancement price, based on a result of the identification as to whether the intermediate price is outside the preset enhancement price range.

In an embodiment, when the intermediate price is not outside the preset enhancement price range, the processor 910 may determine a value equal to the intermediate price as the second enhancement price.

In an embodiment, when the intermediate price is outside the preset enhancement price range, the processor 910 may determine a value equal to the first enhancement price as the second enhancement price.

In an embodiment, when the intermediate price is outside the preset enhancement price range, the processor 910 may determine, as the second enhancement price, a value indicating an upper limit or lower limit of the preset enhancement price range.

In an embodiment, the processor 910 may compare the first enhancement demand based on the first user information with the second enhancement demand based on the second user information, and may determine the intermediate price by adjusting the first enhancement price, based on a result of the comparison.

In an embodiment, the processor 910 may obtain an intermediate price that is higher than the first enhancement price, based on the second enhancement demand being higher than or equal to the first enhancement demand, or may obtain an intermediate price that is lower than the first enhancement price, based on the second enhancement demand being lower than the first enhancement demand.

In an embodiment, the communication interface 920 may perform communication with an external device under a control by the processor 910. For example, the communication interface 920 may perform communication with an external device, such as a payment server or an authentication server, under a control by the processor 910. The communication interface 920 may obtain user information or a user input through communication with an external interface.

In an embodiment, the memory 930 may store a program used by the processor 910 to perform processing and control, and may also store data that is input to or output from the game-providing device 900.

In an embodiment, the processor 930 may store enhancement information regarding the enhancement conditions of the first item among the items in a game, the first user information indicating information about a user who uses the game at the first time point, and the second user information indicating information about a user who uses the game at the second time point.

In an embodiment, the processor 910 may perform a method of providing a game service, by using the program stored in the memory 930. For example, the processor 910 may provide a method of determining the first enhancement price for enhancing the first item, based on the enhancement information and the first user information both stored in the memory 930. The processor 910 may also provide a method of determining the second enhancement price for enhancing the first item, by adjusting the first enhancement price, based on the enhancement information and the second user information both stored in the memory 930.

In an embodiment, the memory 930 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. In an embodiment, the programs stored in the memory 930 may be classified into a plurality of modules according to their functions.

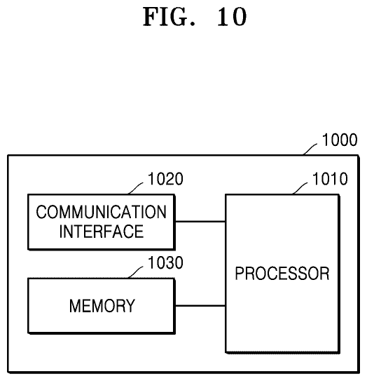

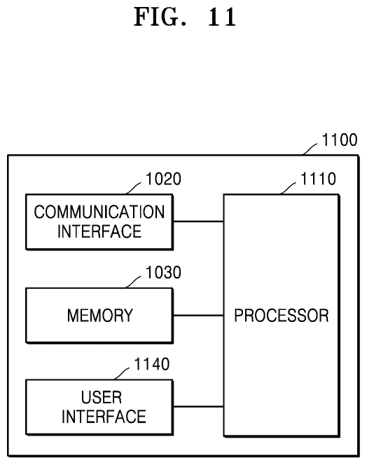

In an embodiment, a method of providing a game service may be performed in the game-providing device 900 or in a server or a user terminal, and at least one component included in the game-providing device 900 may perform the embodiments described above with reference to FIGS. 1 through 8. The method of providing a game service may be performed individually or jointly by the server and the user terminal. Respective configurations of the server and user terminal will now be described in more detail with reference to FIGS. 10 and 11.

FIG. 10 is a block diagram of a specific configuration of a server according to various embodiments.

Referring to FIG. 10, a server 1000 according to some embodiments may include at least one processor 1010, a communication interface 1020, and a memory 1030. Not all of the components illustrated in FIG. 10 are essential components of the server 1000. More or less components than those illustrated in FIG. 10 may constitute the server 1000.

In an embodiment, the processor 1010 typically controls an overall operation of the server 1000. For example, the processor 1010 may control the communication interface 1020, the memory 1030, etc., in general by executing a program stored in the memory 1030. The processor 1010 may control an operation of the server 1000 in this specification by controlling the communication interface 1020, the memory 1030, etc.

In an embodiment, the processor 1010 may obtain enhancement information regarding the enhancement conditions of the first item among the items in a game, obtain the first user information indicating information about a user who uses the game at the first time point, and determine the first enhancement price for enhancing the first item, based on the enhancement information and the first user information.

In an embodiment, an operation of the processor 1010 may correspond to an operation of the processor 910 of the game-providing device 100 described above with reference to FIG. 9, so a detailed description thereof will be omitted.

In an embodiment, the communication interface 1020 may provide a query to a user terminal 1100 under a control by the processor 1010, and may receive response information for the query. In an embodiment, the communication interface 1020 may transmit and receive data to and from the user terminal 1100, and the data transmitted and received to and from the user terminal 1100 may include control data that controls the user terminal 1100 or a program included in the user terminal 1100.

In an embodiment, the memory 1030 may store a program used by the processor 1010 to perform processing and control, and may also store data that is input to or output from the server 1000.

In an embodiment, the processor 1030 may store enhancement information regarding the enhancement conditions of the first item among the items in a game, the first user information indicating information about a user who uses the game at the first time point, and the second user information indicating information about a user who uses the game at the second time point.

In an embodiment, the processor 1010 may perform a method of providing a game service, by using the program stored in the memory 1030.

In an embodiment, the memory 1030 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. In an embodiment, the programs stored in the memory 1030 may be classified into a plurality of modules according to their functions.

In an embodiment, the game providing method may be performed by the server 1000 and the user terminal 1100 together, may be performed individually by the server 1000 and the user terminal 1100, and may be performed by the game-providing device 100.

FIG. 11 is a block diagram of a specific configuration of a user terminal according to various embodiments.

Referring to FIG. 11, the user terminal 1100 according to some embodiments may include at least one processor 1110, a communication interface 1120, a memory 1130, and a user interface 1140. Not all of the components illustrated in FIG. 16 are essential components of the user terminal 1100. More or less components than those illustrated in FIG. 16 may constitute the user terminal 1100.

In an embodiment, the processor 1110 typically controls an overall operation of the user terminal 1100. For example, the processor 1110 may control the communication interface 1120, the memory 1130, the user interface 1140, etc., in general by executing a program stored in the memory 1130. The processor 1110 may control an operation of the user terminal 1100 in this specification by controlling the communication interface 1120, the memory 1130, the user interface 1140, etc.

In an embodiment, the processor 1110 may obtain enhancement information regarding the enhancement conditions of the first item among the items in a game, obtain the first user information indicating information about a user who uses the game at the first time point, and determine the first enhancement price for enhancing the first item, based on the enhancement information and the first user information.

In an embodiment, the processor 1110 may obtain the second user information indicating information about a user who uses the game at the second time point, and may determine the second enhancement price for enhancing the first item, by adjusting the first enhancement price, based on the enhancement information and the second user information.

In an embodiment, an operation of the processor 1110 may correspond to an operation of the processor 910 of the game-providing device 100 described above with reference to FIG. 9, so a detailed description thereof will be omitted.

In an embodiment, the communication interface 1120 may provide a query to the server 1000 under a control by the processor 1110, and may receive response information for the query. In an embodiment, the communication interface 1120 may transmit and receive data to and from the server 1000, and the data transmitted and received to and from the server 1000 may include control data that controls the user terminal 1100 or a program included in the user terminal 1100.

In an embodiment, the communication interface 1220 may include, but is not limited to, a Bluetooth communication interface, a Bluetooth Low Energy (BLE) communication interface, a near field communication (NFC) interface, a wireless local area network (WLAN) (e.g., Wi-Fi) communication interface, a ZigBee communication interface, an infrared Data Association (IrDA) communication interface, a Wi-Fi direct (WFD) communication interface, an ultra wideband (UWB) communication interface, and an Ant+ communication interface.

In an embodiment, the communication interface 1120 transmits or receives wireless signals to or from at least one selected from a base station, an external terminal, and a server on a mobile communication network. Here, examples of the wireless signal may include a voice call signal, a video call signal, and various types of data according to text/multimedia message exchange.

In an embodiment, the memory 1130 may store a program used by the processor 1110 to perform processing and control, and may also store data that is input to or output from the user terminal 1100. In an embodiment, the memory 1130 may store game-related information. For example, the processor 1130 may store enhancement information regarding the enhancement conditions of the first item among the items in a game, the first user information indicating information about a user who uses the game at the first time point, and the second user information indicating information about a user who uses the game at the second time point.

In an embodiment, the processor 1110 may perform a method of providing a game service, by using the program stored in the memory 1130.

In an embodiment, the memory 1130 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. In an embodiment, the programs stored in the memory 1130 may be classified into a plurality of modules according to their functions.

In an embodiment, the user interface 1140 may include various interfaces. For example, the user interface 1140 may include various interfaces, such as a key pad, a dome switch, a voice input interface, a fingerprint input interface, a touch input interface (e.g., a capacitive overlay type, a resistive overlay type, an infrared beam type, a surface acoustic wave type, an integral strain gauge type, or a piezo electric type), a camera, a jog wheel, and a jog switch, and may link various sensors, such as an acceleration sensor, a position sensor, a temperature sensor, and an optical sensor. Of course, embodiments are not limited thereto.

According to an embodiment, the user interface 1140 may further include an output interface (not shown). The output interface may include at least one selected from a liquid crystal display (LCD), a thin film transistor-liquid crystal display (TFT-LCD), an organic light-emitting diode (OLED), a flexible display, a three-dimensional (3D) display, and an electrophoretic display. When a display forms a layer structure together with a touch pad to construct a touch screen, the display may be used as an input device as well as an output device. The output interface (not shown) may include, but is not limited to, an LED lamp, a vibration motor, a speaker, a flash, etc.

In an embodiment, the user interface 1140 may output a notification about game information in the form of an image, a video, a sound, a vibration, a lamp, etc.

In an embodiment, the user interface 1140 may include an interface that includes at least one of the enhancement information, the first user information, the second user information, the first enhancement price, and the second enhancement price all described above with reference to the above drawings. However, the interface including at least one of the enhancement information, the first user information, the second user information, the first enhancement price, and the second enhancement price has been described as an example of the user interface 1140, and the user interface 1140 according to the disclosure may include more various interfaces.

The device described above (e.g., the game-providing device, the server, the user terminal, or, etc.) may be implemented as a hardware component, a software component, and/or a combination of hardware components and software components. For example, the devices and components described in the embodiments may be implemented using at least one general-use computer or special-purpose computer, such as, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device (e.g., at least one processor) may execute an operating system (OS) and one or more software applications running on the OS. In addition, the processing device may access, store, manipulate, process, and generate data in response to execution of software. For ease of understanding, a single processing device may be described as being used, but one of ordinary skill in the art will recognize that the processing device may include a plurality of processing elements and/or a plurality of types of processing elements. For example, the processing device may include a plurality of processors or a single processor, and a controller. The processing device may have another processing configuration, such as a parallel processor.

The software may include a computer program, a code, instructions, or a combination of one or more of the foregoing, and may configure a processing device so that the processing device can operate as intended, or independently or collectively give instructions to the processing device. The software and/or the data may be permanently or temporarily embodied in any type of machine, component, physical device, virtual equipment, computer storage media or devices, or transmitted signal waves, such that the software and/or the data is interpreted by the processing device or provides an instruction or data to the processing device. The software may be distributed over a networked computer system and stored or executed in a distributed manner. The software and the data may be stored on one or more computer readable recording media.

A method according to an example may be embodied as program commands executable by various computer means and may be recorded on a computer-readable recording medium. The computer-readable recording medium may include program commands, data files, data structures, and the like separately or in combinations. The program commands to be recorded on the computer-readable recording medium may be specially designed and configured for examples or may be well-known to and be usable by one of ordinary skill in the art of computer software. Examples of a computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are high-level language codes that can be executed by a computer by using an interpreter or the like as well as machine language codes made by a compiler. The hardware devices can be configured to function as one or more software modules so as to perform operations according to examples, or vice versa.

While the disclosure has been particularly shown and described with reference to examples thereof, it will be understood by those of ordinary skill in the art that various changes in form and details may be made therein without departing from the spirit and scope of the disclosure. For example, an appropriate result may be attained even when the above-described techniques are performed in a different order from the above-described method, and/or components, such as the above-described system, structure, device, and circuit, are coupled or combined in a different form from the above-described methods or substituted for or replaced by other components or equivalents thereof.

Therefore, other implementations, other embodiments, and equivalents of the claims may also fall within the scope of the claims described below.

Provided is a method of determining an appropriate enhancement price for a gaming environment, by adjusting an enhancement price by reflecting actual user demand and payment willingness through various embodiments. Furthermore, embodiments enable an item to be enhanced based on reasonable enhancement prices, thereby providing a reasonable game service environment against indiscriminate power inflation and decline in item value.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, performed by a game-providing device, of providing a game service, the method comprising:
obtaining enhancement information regarding enhancement conditions of a first item among a plurality of items in a game;
obtaining first user information indicating information about a user who uses the game at a first time point; and
determining a first enhancement price for enhancing the first item, based on the enhancement information and the first user information.

2. The method of claim 1, further comprising:
obtaining second user information indicating information about a user who uses the game at a second time point; and
determining a second enhancement price for enhancing the first item, by adjusting the first enhancement price, based on the enhancement information and the second user information.

3. The method of claim 2, wherein the determining of the second enhancement price comprises:
determining an intermediate price for enhancing the first item, based on the enhancement information and the second user information; and
determining the second enhancement price, based on identifying whether the intermediate price is outside a selected enhancement price range.

4. The method of claim 3, wherein the determining of the second enhancement price, based on identifying whether the intermediate price is outside the selected enhancement price range, comprises determining a value equal to the intermediate price as the second enhancement price, when the intermediate price is not outside the selected enhancement price range.

5. The method of claim 3, wherein the determining of the second enhancement price, based on identifying whether the intermediate price is outside the selected enhancement price range, comprises determining a value equal to the first enhancement price as the second enhancement price, when the intermediate price is outside the selected enhancement price range.

6. The method of claim 3, wherein the determining of the second enhancement price, based on identifying whether the intermediate price is outside the selected enhancement price range, comprises determining, as the second enhancement price, a value indicating an upper limit or lower limit of the selected enhancement price range when the intermediate price is outside the selected enhancement price range.

7. The method of claim 1, wherein the user who uses the game has a level within a selected range from a wearable level of the first item.

8. The method of claim 1, wherein the enhancement information comprises at least one of an enhancement type of the first item, an enhancement section of the first item, the number of consecutive enhancements of the first item, a wearable level of the first item, and an ability value of the first item.

9. The method of claim 2, wherein the first user information and the second user information include at least one of an amount of goods distributed to users of the game service, the number of the users, an average profit of the users, an enhancement demand for the first item, the number of users for each level section, an average profit of the users for each level section, an enhancement demand of the users for each level section for the first item, and an increase/decrease rate of the enhancement demand.

10. The method of claim 3, wherein the determining of the intermediate price comprises:
comparing a first enhancement demand based on the first user information with a second enhancement demand based on the second user information; and
determining the intermediate price by adjusting the first enhancement price, based on a result of the comparing.

11. The method of claim 10, wherein the determining of the intermediate price by adjusting the first enhancement price comprises:
obtaining an intermediate price that is higher than or equal to the first enhancement price, based on the second enhancement demand being higher than or equal to the first enhancement demand; or
obtaining an intermediate price that is lower than the first enhancement price, based on the second enhancement demand being lower than the first enhancement demand.

12. A game-providing device comprising:
a memory storing instructions; and
at least one processor functionally connected to the memory and configured to execute the instructions stored in the memory,
wherein the at least one processor is configured to execute the instructions to:
obtain enhancement information regarding enhancement conditions of a first item among a plurality of items in a game;
obtain first user information indicating information about a user who uses the game at a first time point; and
determine a first enhancement price for enhancing the first item, based on the enhancement information and the first user information.

13. The game-providing device of claim 12, wherein the at least one processor is further configured to execute the instructions to:
obtain second user information indicating information about a user who uses the game at a second time point; and
determine a second enhancement price for enhancing the first item, by adjusting the first enhancement price, based on the enhancement information and the second user information.

14. The game-providing device of claim 13, wherein the at least one processor is further configured to execute the instructions to:
determine an intermediate price for enhancing the first item, based on the enhancement information and the second user information; and
determine the second enhancement price, based on identifying whether the intermediate price is outside a selected enhancement price range.

15. The game-providing device of claim 14, wherein the at least one processor is further configured to execute the instructions to determine a value equal to the intermediate price as the second enhancement price, when the intermediate price is not outside the selected enhancement price range.

16. The game-providing device of claim 14, wherein the at least one processor is further configured to execute the instructions to determine a value equal to the first enhancement price as the second enhancement price, when the intermediate price is outside the selected enhancement price range.

17. The game-providing device of claim 14, wherein the at least one processor is further configured to execute the instructions to determine, as the second enhancement price, a value indicating an upper limit or lower limit of the selected enhancement price range, when the intermediate price is outside the selected enhancement price range.

18. The game-providing device of claim 12, wherein the user who uses the game has a level within a selected range from a wearable level of the first item.

19. The game-providing device of claim 12, wherein the enhancement information comprises at least one of an enhancement type of the first item, an enhancement section of the first item, the number of consecutive enhancements of the first item, a wearable level of the first item, and an ability value of the first item.

20. The game-providing device of claim 13, wherein the first user information and the second user information include at least one of an amount of goods distributed to users who use the game, the number of the users, an average profit of the users, an enhancement demand for the first item, the number of users for each level section, an average profit of the users for each level section, an enhancement demand of the users for each level section for the first item, and an increase/decrease rate of the enhancement demand.

21. The game-providing device of claim 14, wherein the at least one processor is further configured to execute the instructions to:
compare a first enhancement demand based on the first user information with a second enhancement demand based on the second user information; and
determine the intermediate price by adjusting the first enhancement price, based on a result of the comparison.

22. The game-providing device of claim 21, wherein the at least one processor is further configured to execute the instructions to:
obtain an intermediate price that is higher than or equal to the first enhancement price, based on the second enhancement demand being higher than or equal to the first enhancement demand; or
obtain an intermediate price that is lower than the first enhancement price, based on the second enhancement demand being lower than the first enhancement demand.

23. A server comprising:
a memory storing instructions; and
at least one processor functionally connected to the memory and configured to execute the instructions,
wherein the at least one processor is configured to execute the instructions to:
obtain enhancement information regarding enhancement conditions of a first item among a plurality of items in a game;
obtain first user information indicating information about a user who uses the game at a first time point; and
determine a first enhancement price for enhancing the first item, based on the enhancement information and the first user information.

24. A user terminal for providing a game service, the user terminal comprising:
a user interface configured to receive a user input;
a memory storing instructions; and
at least one processor functionally connected to the user interface and the memory and configured to execute the instructions,
wherein the at least one processor is configured to execute the instructions to:
obtain enhancement information regarding enhancement conditions of a first item among a plurality of items in a game;
obtain first user information indicating information about a user who uses the game at a first time point; and
determine a first enhancement price for enhancing the first item, based on the enhancement information and the first user information.

25. A computer-readable recording medium having recorded thereon a program, which, when executed by a computer, performs a method of providing a game service, the method comprising:
obtaining enhancement information regarding enhancement conditions of a first item among a plurality of items in a game;
obtaining first user information indicating information about a user who uses the game at a first time point; and
determining a first enhancement price for enhancing the first item, based on the enhancement information and the first user information.
